(19) United States
(12) Patent Application Publication
(10) Pub. No.: US 2012/0082904 A1
(43) Pub. Date: Apr. 5, 2012

(54) HIGH ENERGY DENSITY ALUMINUM BATTERY

(76) Inventors: Gilbert M. Brown, Knoxville, TN (US); Mariappan Parans Paranthaman, Knoxville, TN (US); Sheng Dai, Knoxville, TN (US); Nancy J. Dudney, Knoxville, TN (US); Arumugan Manthiram, Austin, TX (US); Timothy J. Mclntyre, Knoxville, TN (US); Xiago-Guang Sun, Knoxville, TN (US)

(21) Appl. No.: 12/895,487

(22) Filed: Sep. 30, 2010

(51) Int. Cl. H01M 10/02; H01M 4/58; H01M 6/16; H01M 6/04; H01M 10/04; H01M 4/50; H01M 4/02

(52) U.S. Cl. 429/338; 429/224; 429/231.5; 429/206; 429/209; 429/188; 429/199; 29/623.1; 429/340

(57) ABSTRACT

Compositions and methods of making are provided for a high energy density aluminum battery. The battery comprises an anode comprising aluminum metal. The battery further comprises a cathode comprising a material capable of intercalating aluminum ions during a discharge cycle and deintercalating the aluminum ions during a charge cycle. The battery further comprises an electrolyte capable of supporting reversible deposition and stripping of aluminum at the anode, and reversible intercalation and deintercalation of aluminum at the cathode.

### STATEMENT OF GOVERNMENT INTEREST

The invention was made with government support under contract number DE-FOA-0000207 by the Department of Energy. The Government has certain rights in the invention.

### BACKGROUND

There is great interest and motivation to make a transition from fossil energy based electricity to the generation from renewable sources such as solar or wind. These sources offer enormous potential for meeting future energy demands. However, the use of electricity generated from these intermittent sources requires efficient electrical energy storage. For large-scale, solar- or wind-based electrical generation to be practical, the development of new electrical energy storage systems are critical to meeting continuous energy demands and effectively leveling the cyclic nature of these energy sources. Transformational developments in electrical energy storage are needed. In particular, there are needs for secondary batteries made from novel materials that would increase the level of energy storage per unit volume and decrease dead weight while maintaining stable electrode-electrolyte interfaces. There is potential for increases in charge density by utilizing multielectron redox couples, such as in an aluminum battery.

The currently available electric energy storage technologies fall far short of the requirements for efficiently providing electrical energy for transportation vehicles, commercial and residential electrical and heating applications, and even for many electrically powered consumer devices. In particular, electrical storage devices with high energy and power densities are needed to power electric vehicles with performance comparable to that of vehicles powered by petroleum-fueled internal combustion engines.

Previous attempts to utilize aluminum anodes in secondary batteries have been plagued by high corrosion rates, parasitic hydrogen evolution, and a decrease in the reversible electrode potential (i.e., cell voltage is considerably lower than the theoretical value) due to formation of oxide film on the anode surface are problems.

### SUMMARY

Compositions and methods of making are disclosed for high energy density aluminum batteries.

In one embodiment, the battery comprises an anode comprising aluminum metal. The battery further comprises a cathode comprising a material capable of intercalating aluminum ions during a discharge cycle and deintercalating the aluminum ions during a charge cycle. The battery further comprises an electrolyte capable of supporting reversible deposition and stripping of aluminum at the anode, and reversible intercalation and deintercalation of aluminum at the cathode.

In certain embodiments, the battery is a primary battery. In some embodiments, the primary battery comprises a cathode material selected from the group consisting of Ti(AlCl₄)₂, MnCl(AlCl₄), Co(AlCl₄)₂.

In certain embodiments, the battery is a secondary battery. In one embodiment, the secondary battery maintains a discharge capacity of at least 50% of an initial discharge capacity after 50 cycles.

In certain embodiments, the cathode material in the battery is selected from the group consisting of Mn₂O₄, Ti(AlCl₄)₂, MnCl(AlCl₄), Co(AlCl₄)₂, and V₂O₅. In another one particular embodiment, the cathode material comprises spinel-Mn₂O₄. In another particular embodiment, the cathode material comprises V₂O₅.

In certain embodiments, the electrolyte in the battery comprises an ionic liquid. In some embodiments, the ionic liquid is an aluminate selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, and mixtures thereof. In additional embodiments, the electrolyte further comprises aluminum chloride, and the ratio of aluminum chloride to the aluminate is greater than 1:1. In yet additional embodiments, the electrolyte in the battery further comprises an alkali metal halide additive. In some embodiments, the alkali metal halide additive is selected from the group consisting of: NaCl, KCl, NH₄Cl, and mixtures thereof.

In one embodiment, the electrolyte in the battery comprises ethylmethylimidazolium tetrachloroaluminate and aluminum chloride. In another embodiment, the molar ratio of aluminum chloride to ethylmethylimidazolium tetrachloroaluminate is greater than 1:1. In yet another embodiment, the electrolyte further comprises an alkali metal halide additive. In some embodiments, the alkali metal halide additive is selected from the group consisting of: NaCl, KCl, NH₄Cl, and mixtures thereof.

In yet another embodiment, the electrolyte in the battery is a neutral ionic liquid electrolyte comprising a cation having one of the following structures:

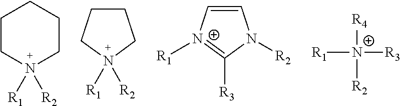

wherein R₁, R₂, R₃, and R₄ each independently comprise a non-ionizable substitutent. The electrolyte further comprises an anion having one of the following structures: CF₃SO₃⁻, B(CO₂)₄⁻, N(SO₂CF₂CF₃)₂⁻, N(SO₂CF₃)₂⁻, N(SO₂F)₂⁻, PF₆⁻, BF₄⁻, and BF₄₋ₓx(CₙF₂ₙ₊₁)x⁻, wherein x=1, 2, or 3, and n=1, 2, 3, 4, 5, 6, 7, 8, 9, or 10.

In another embodiment, the electrolyte in the battery comprises an organic solvent having a high dielectric constant. In some embodiments, the organic solvent is selected from the group consisting of propylene carbonate, ethylmethylsulfone, ethylmethoxyethylsulfone, and methoxyethylmethylsulfone. In certain embodiments, the cathode material in the battery is selected from the group consisting of spinel-Mn₂O₄, Ti(AlCl₄)₂, MnCl(AlCl₄), Co(AlCl₄)₂, and V₂O₅.

In certain embodiments, the battery is used in a grid storage application, vehicle battery application, portable electronic device application, or standard cell size battery application.

In another embodiment, the battery comprises an aluminum metal anode. The battery further comprises a λ-MnO₂ cathode capable of intercalating aluminum ions during a discharge cycle and deintercalating the aluminum ions during a charge cycle. The battery further comprises an ionic liquid electrolyte comprising aluminum chloride and ethylmethylimidazolium tetrachloroaluminate, having a molar ratio of aluminum chloride to ethylmethylimidazolium tetrachloroaluminate greater than 1:1, wherein the electrolyte is capable of supporting reversible deposition and stripping of aluminum at the anode, and reversible intercalation and deintercalation of aluminum at the cathode. In one embomdiment, the battery maintains a discharge capacity of at least 50% of an initial discharge capacity after 50 cycles.

In another embodiment, a method of making a battery comprises providing an anode comprising aluminum metal. The method further comprises providing a cathode comprising a material capable of intercalating aluminum ions during a discharge cycle and deintercalating the aluminum ions during a charge cycle. The method further comprises providing an electrolyte capable of supporting reversible deposition and stripping of aluminum at the anode, and reversible intercalation and deintercalation of aluminum at the cathode.

In certain embodiments, the method of making a battery comprises providing a cathode material selected from the group consisting of Mn₂O₄, Ti(AlCl₄)₂, MnCl(AlCl₄), Co(AlCl₄)₂, and V₂O₅.

In certain embodiments, the method of making a battery comprises providing an electrolyte having aluminum chloride and an ionic liquid aluminate selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, and mixtures thereof. In some embodiments, the ratio of aluminum chloride to the aluminate in the electrolyte provided is greater than 1:1.

In certain embodiments, the method of making a battery comprises providing an electrolyte having aluminum chloride, an ionic liquid aluminate, and an alkali metal halide additive.

In one particular embodiment, the method of making a battery comprises providing an electrolyte comprising aluminum chloride and ethylmethylimidazolium tetrachloroaluminate; wherein the molar ratio of aluminum chloride to ethylmethylimidazolium tetrachloroaluminate is greater than 1:1. In another embodiment, the method further comprises providing an alkali metal halide additive in the electrolyte.

In other embodiments, the method of making a battery comprises providing a neutral ionic liquid electrolyte having a cation having one of the following structures:

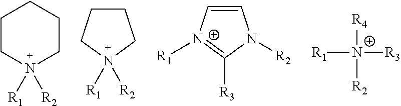

wherein R₁, R₂, R₃, and R₄ each independently comprise a non-ionizable substitutent; and

a anion having one of the following structures: CF₃SO₃⁻, B(CO₂)₄⁻, N(SO₂CF₂CF₃)₂⁻, N(SO₂CF₃)₂⁻, N(SO₂F)₂⁻, PF₆⁻, BF₄⁻, and BF₄₋ₓ(CₙF₂ₘ₊₁)ₓ⁻), wherein x=1, 2, or 3, and n=1, 2, 3, 4, 5, 6, 7, 8, 9, or 10.

In yet other embodiments, the method of making a battery comprises providing an organic solvent electrolyte selected from the group consisting of propylene carbonate, ethylmethylsulfone, ethylmethoxyethylsulfone, and methoxyethylmethylsulfone.

### BRIEF DESCRIPTION OF THE DRAWINGS

FIG. 1 depicts a comparison of the theoretical energy density of an aluminum battery with other batteries.

FIGS. 2A and 2B depict aluminum dissolution and deposition as a function of the electrolyte composition (acidic, basic, or neutral).

FIGS. 3A and 3B depicts aluminum dissolution and deposition for an acidic electrolyte mixture of 2:1 AlCl₃:EMIC for a number of cycles.

FIGS. 4A and 4B depict aluminum anode electrochemical behavior in an acidic electrolyte mixture of 2:1 AlCl₃:EMIC for a number of cycles.

FIGS. 5A and 5B depict electrochemical responses for MnO₂ and AlMn₂O₄ cathodes in an acidic electrolyte mixture of 2:1 AlCl₃:EMIC.

### DETAlLED DESCRIPTION

As used herein, the singular forms “a,” “an,” and “the” include plural referents unless the context clearly dictates otherwise. For example, reference to “a substituent” encompasses a single substituent as well as two or more substituents, and the like.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure, and are-not meant to be limiting in any fashion.

As used herein, the following terms have the following meanings unless expressly stated to the contrary. It is understood that any term in the singular may include its plural counterpart and vice versa.

As used herein, the term “aluminum battery” refers to an aluminum-ion battery, unless specified otherwise.

As used herein, the term “aluminum metal” includes aluminum metal, aluminum metal alloys, or any other anode composition that includes aluminum metal, or combinations thereof, unless specified otherwise. In certain embodiments, an aluminum metal alloy may comprise at least one of the following alloying elements: copper, magnesium, manganese, silicon, titanium, or zinc. In other embodiments, the aluminum metal may include at least one insertion compound such as graphite, silicon nanowires, or titanium oxide.

As used herein, the term “aluminum ion” may refer to any ion comprising aluminum, including but not limited to Al³⁺, AlCl₄⁻, and Al₂Cl₇⁻.

As used herein, the terms “primary” and “primary battery” refer to any kind of battery in which the electrochemical reaction is generally not reversible (i.e., the reaction cannot be reversed by running a current into the cell to restore the capacity of the battery).

As used herein, the terms “secondary” and “secondary battery” refer to rechargeable batteries wherein the electrochemical reactions are electrically reversible (i.e., the reaction can be reversed by running a current into the cell to restore the capacity of the battery). In certain embodiments, the secondary battery can achieve a number of “cycles” (discharge and charge) while maintaining a “functional discharge capacity” (i.e., the discharge capacity is more than 50%, 60%, 70%, 80%, or 90% of the initial discharge capacity).

As used herein, the term “room temperature ionic liquid” may refer to an ionic liquid electrolyte that is in its liquid state at room temperature (i.e., approximately 20-25° C.). In certain embodiments, the room temperature ionic liquid electrolyte remains in liquid state over a wide composition range. In one non-limiting example, an electrolyte comprising aluminum chloride and ethylmethylimidazolium tetrachloroaluminate (“EMIC”) is in a liquid state as low as approximately 8° C. at approximately a 1:2 molar ratio of aluminum chloride:EMIC. Additionally, the electrolyte remains in a liquid state as low as −98° C. for a 2:1 molar ratio of aluminum chloride:EMIC. Such ionic liquids have the potential to deposit highly reactive metals such as aluminum that cannot be deposited by an aqueous solution.

As used herein, the term “high dielectric constant” may refer to an electrolyte that is electrically insulating and ionically conducting.

In one embodiment, the battery may be formed with an aluminum anode. Aluminum is an attractive anode material for energy storage and conversion. Its relatively low atomic weight of 26.98 g/mol along with its trivalence gives a gram-equivalent weight of 8.99 and a corresponding electrochemical equivalent weight of 2.98 amp-hours per gram (Ah/g), compared with 3.86 Ah/g for lithium, 2.20 Ah/g for magnesium and 0.82 Ah/g for zinc. From a volume standpoint, aluminum should yield 8.04 Ah/cm³, compared with 2.06 Ah/cm³ for lithium, 5.85 Ah/cm³ for zinc and 3.83 Ah/cm³ for magnesium.

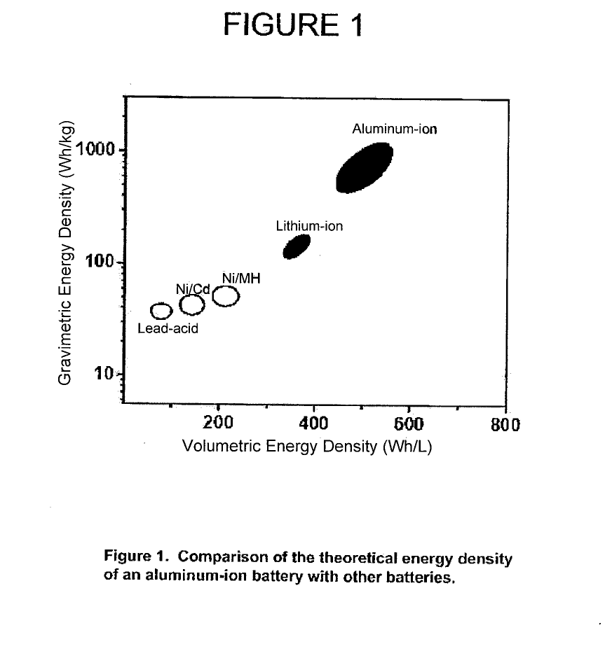

In comparison with a lithium battery, the theoretical voltage for aluminum is similar to lithium (2.86 volts v. 3.4 volts, respectively), and due to the mass of aluminum and its trivalency, the aluminum battery has the potential to yield 8-9 times better storage capacity than a lithium-ion battery. If a cathode of approximately the same mass is used in each battery, the aluminum battery can provide approximately 4 times higher energy than the lithium-ion battery. FIG. 1 provides a comparison of the theoretical energy density for various batteries, including aluminum and lithium. Furthermore, an aluminum battery does not necessarily develop a solid electrolyte interface (SEI) layer between electrolye and electrode. Also, the aluminum anode can be the protective containment (i.e., it is self-supporting). Additionally, aluminum is both an abundant and relatively inexpensive metal, and the use of a nonflammable ionic liquid electrolyte may provide an increased margin of safety.

Overall, an aluminum battery has the capability of achieving a much higher energy density than a lithium-ion battery. Aluminum batteries have the potential for providing energy densities exceeding 200 Wh/kg (mass density) and 300 Wh/liter (volumetric density) at system-level costs below $250/kWh for various applications. In certain embodiments, the aluminum battery can be used in grid storage applications, vehicle battery applications, portable electronic device application, or standard cell size battery applications. In one particular embodiment, the aluminum battery is used for a grid storage application. In another particular embodiment, the aluminum battery is used in a vehicle battery application.

In one embodiment, the aluminum battery is a primary battery. In another embodiment, the aluminum battery is a secondary battery. In certain embodiments, the secondary battery is capable of having at least 50, 100, 150, 200, or 500 cycles prior to battery failure. In some embodiments, battery failure is related to the functional discharge capacity becoming only 50%, 60%, 70%, 80%, or 90% of the initial discharge capacity after a number of cycles. In other embodiments, battery failure is related to the inability to recharge the battery due to dendrite formation, oxide film formation, or other buildup on the anode or cathode. In one particular embodiment, the secondary battery is capable of having a functional discharge capacity greater than 50% of the initial discharge capacity after 50 cycles. In another embodiment, the secondary battery is capable of having a functional discharge capacity greater than 50% of the initial discharge capacity after 150 cycles.

In certain embodiments, the aluminum battery comprises: (1) an anode comprising aluminum metal, (2) a cathode comprising a material capable of intercalating aluminum ions during a discharge cycle and deintercalating the aluminum ions during a charge cycle, and (3) an electrolyte capable of supporting reversible deposition and stripping of aluminum at the anode, and reversible intercalation and deintercalation of aluminum at the cathode.

### Anode

In certain embodiments, the anode material comprises aluminum metal. In other embodiments, the anode material comprises an aluminum metal alloy. Non-limiting examples of aluminum metal alloys include an alloying element selected from the group consisting of copper, magnesium, manganese, silicon, titanium, zinc, and mixtures thereof. In yet other embodiments, the anode material comprises an insertion compound. Non-limiting examples of insertion compounds include graphite, silicon nanowires, titanium oxide, and mixtures thereof.

In certain embodiments, during the manufacture of the battery, the anode material is subjected to a pretreatment step to remove oxides from the material. In one embodiment, oxides are removed from the aluminum anode material through an electrochemical reduction step known to one of ordinary skill in the art.

### Electrolyte

Suitable electrolytes for an aluminum battery are electrochemically stable within the operation window of the electrodes. In other words, the electrolyte is capable of supporting reversible deposition and stripping of aluminum at the anode, and reversible intercalation and deintercalation of aluminum at the cathode. Suitable electrolytes may include materials that assist in achieving a wide electrochemical window, good ionic conductivity, improved rate capability, long cycle ability, good capacity retention, and compatibility with the anode and cathode materials.

In certain embodiments, the electrolyte materials may be optimized through the addition of suitable co-solvents that may assist in reducing viscosity (increasing mobility) and/or increasing charge transfer number (increasing salt dissociation).

In certain embodiments, the electrolyte comprises an ionic liquid. In some embodiments, the ionic liquid is a room temperature ionic liquid. In certain embodiments, the room temperature ionic liquid comprises an aluminate material selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, and aralkylsulfonium aluminates.

In certain embodiments, the electrolyte includes a compound that is capable of assisting in dissociating Al³⁺ for intercalation. The compound is selected from the group consisting of: aluminum chloride (AlCl₃), aluminum triflate, butylpyridium chloride, 1-methyl-3-propylimidizolium chloride, a triazolium chloride, or an aluminum bis(trifluoromethanesulfonyl) imide salt. In particular, aluminum triflate and aluminum bis(trifluoromethanesulfonyl) imide salts may provide electron delocalization of the anions so that Al³⁺ will not be tightly bonded.

In one embodiment, the molar ratio of the compound (e.g., aluminum chloride) to the aluminate in the ionic liquid is greater than 1:1 aluminum chloride:aluminate, which forms an acidic electrolyte. In other embodiments, the molar ratio of aluminum chloride to aluminate in the electrolyte is greater than 1.5:1, 2:1, 3:1, 4:1, 5:1, or 10:1. In yet other embodiments, the molar ratio of aluminum chloride to aluminate is approximately 1.5:1, 2:1, 3:1, 4:1, 5:1, or 10:1.

In these compositions comprising excess aluminum chloride, the predominant aluminum species in solution is an anion such as AlCl₄⁻ or Al₂Cl₇⁻. These electrolyte compositions can prevent the formation of oxides on the aluminum anode surface as well as eliminate hydrogen gas evolution. Additionally, acidic electrolyte compositions can minimize the evolution of Cl₂, which can be prevalent in basic electrolyte compositions.

In one particular embodiment, the ionic liquid comprises ethylmethylimidazolium tetrachloroaluminate (“EMIC”). In another embodiment, the ionic liquid comprises aluminum chloride added to the EMIC. The molar ratio of aluminum chloride to EMIC in the electrolyte material is greater than 1:1 in certain embodiments, wherein such combination creates an acidic solution. In other embodiments, the molar ratio of aluminum chloride to EMIC is greater than 1.5:1, 2:1, 3:1, 4:1, 5:1, or 10:1. In yet other embodiments, the molar ratio of aluminum chloride to EMIC is approximately 1.5:1, 2:1, 3:1, 4:1, 5:1, or 10:1.

Adjustment of the molar ratio of aluminum chloride to the aluminate can affect the Lewis acidity of the ionic liquid. At AlCl₃ mole fractions less than 0.5 in the electrolyte, the anions present are the Lewis bases Cl⁻ and AlCl₄; hence these melts are regarded as basic. On the other hand, at AlCl₃ mole fractions greater than 0.5, the stable anions are AlCl₄⁻ and Al₂Cl₇⁻. Since Al₂Cl₇⁻ is a potential source of the Lewis acid AlCl₃, these melts are regarded as acidic. Adjustment of the molar ratio of AlCl₃ changes the Lewis acidity of the AlCl₃-EMIC ionic liquid. This is expected to be a consideration in the design of the battery because it has been demonstrated that the deposition of aluminum occurs from the acidic medium.

In such a reaction, excess AlCl₃ dimerizes in the medium to form Al₂Cl₆, and the equilibrium occurs when AlCl₃ is dissolved in the aluminate (EMIC, for example) to form AlCl₄⁻ and Al₂Cl₇⁻, as shown below in equations (1) and (2):

[Al₂Cl₆]+Cl⁻ [symbol] [Al₂Cl₇]⁻ (1)

2[AlCl₄]⁻ [symbol] [Al₂Cl₇]⁻+Cl⁻ (2)

In acidic electrolytes, the Al₂Cl₇⁻ species is the electrochemically active species for deposition of aluminum metal according to the following net reaction (3):

4Al₂Cl₇⁻+3e→Al+7AlCl₄⁻ (3)

A neutral ionic liquid electrolyte possesses the widest electrochemical window for electrolyte solutions such as AlCl₃-EMIC. Therefore, in certain embodiments, it may be beneficial to have a neutral electrolyte solution. However, there are difficulties maintaining a neutral electrolyte composition comprising AlCl₃-EMIC, for example. Therefore, in certain embodiments, an alkali metal halide additive (i.e., neutralizing compound) can be added to the originally acidic electrolyte. In certain embodiments, the neutralizing compound is selected from the group consisting of NaCl, KCl, NH₄Cl, and mixtures thereof. In one embodiment, the neutralizing compound is NaCl. In other embodiments, the neutralizing compound is KCl or, NH₄Cl. The salt neutralizes the Al₂Cl₇⁻ anions via the reaction in equation (4) (wherein the neutralizing compound is NaCl in this non-limiting example):

NaCl(s)+[Al₂Cl₇⁻] [symbol] Na⁺+[AlCl₄]⁻ (4)

In other embodiments, the electrolyte comprises a neutral ionic liquid electrolyte having:

a cation with one of the following structures:

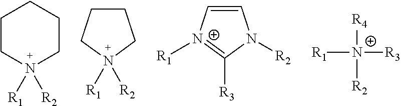

wherein R₁, R₂, R₃, and R₄ each independently comprise a non-ionizable substitutent such as, for example, various hydrocarbons, alkyls, fluoro-alkyls, aryls, and ethers; and

an anion having one of the following structures: CF₃SO₃⁻, B(CO₂)₄⁻, N(SO₂CF₂CF₃)₂⁻, N(SO₂CF₃)₂⁻, N(SO₂F)₂⁻, PF₆⁻, BF₄⁻, and BF₄₋ₓ(CₙF₂ₙ₊₁)ₓ⁻, wherein x=1, 2, or 3, and n=1, 2, 3, 4, 5, 6, 7, 8, 9, or 10.

In certain embodiments, the cation in the neutral ionic liquid is selected from the group consisting of: imidazolium, pyrrolidinium, piperidinium, triazolium, and tetraalkylammonium.

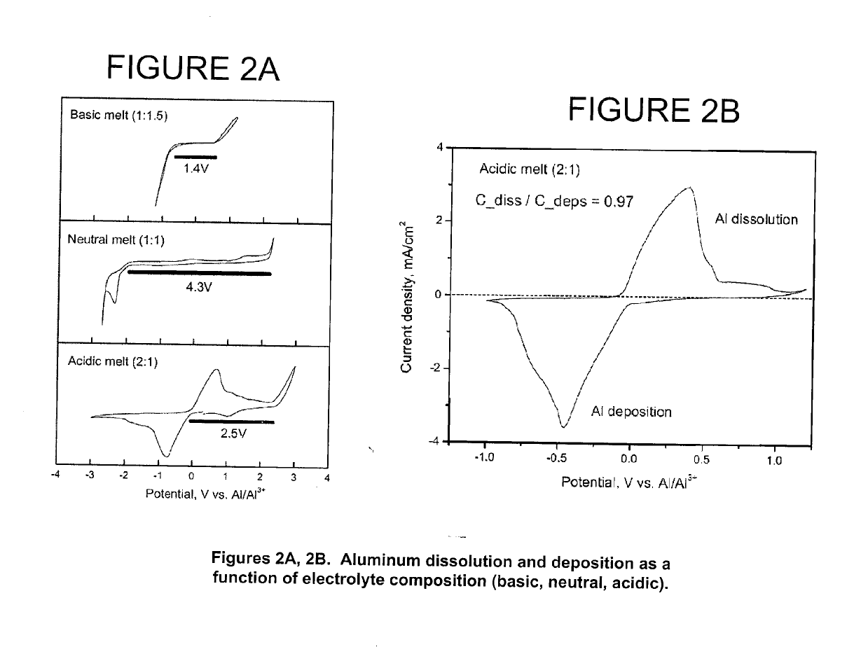

In yet another embodiment, the electrolyte comprises an organic solvent having a wide electrochemical window (e.g., similar or wider than the neutral melt window between −2 V and 2.5 V as shown in FIG. 2A) and a high dielectric constant. In certain embodiments, the organic solvent is selected from the group consisting of propylene carbonate, ethylmethylsulfone, ethylmethoxyethylsulfone, and methoxyethylmethylsulfone.

### Cathode

In certain embodiments, the cathode comprises a material capable of intercalating aluminum ions during a discharge cycle and deintercalating the aluminum ions during a charge cycle. The cathode must readily incorporate Al(III), either as an anion or as the Al(III) cation after shedding the Cl⁻ ligands. For each equivalent of Al which is plated on the anode, three equivalents of AlCl₄⁻ will need to be incorporated in the cathode. The electrolyte will tend to become more basic as Al is plated on the anode, but part of this problem will be alleviated by incorporation of the AlCl₄⁻ anions in the cathode.

In certain embodiments, the cathode comprises an active material selected from the group consisting of: λ-MnO₂ (or λ-Mn₂O₄), Ti(AlCl₄)₂, MnCl(AlCl₄), Co(AlCl₄)₂, and V₂O₅. In certain embodiments, the battery is a primary battery and the cathode is a material selected from the group consisting of Ti(AlCl₄)₂, MnCl(AlCl₄), and Co(AlCl₄)₂.

In certain embodiments, aluminum is inserted into the cathode material lattice. In one particular embodiment, aluminum is inserted into spinel-Mn₂O₄ to form spinel AlMn₂O₄. In another embodiment, the cathode material may comprise layered structures of V₂O₅ aerogels and Al³⁺. Hence, AlₓV₂O₅ material can be used as a possible cathode material for Al(III) insertion.

In certain embodiments, these active components can be mixed with a carbon material (such as carbon black, for example) to make them conducting, and mixed with a binder (such as PVdF binder in N-methylpyrrolidinole, for example) to hold the material together. In some embodiments, the cathode comprises between approximately 50-90% of AlMn₂O₄, Ti(AlCl₄)₂, MnCl(AlCl₄), Co(AlCl₄)₂, and/or AlₓV₂O₅, 1-20% of binder, and 1-40% of carbon material. In one particular embodiment, the cathode comprises approximately 80% of MnO₂ or AlMn₂O₄, approximately 10% of PVdF binder in N-methylpyrrolidinole, and approximately 10% of carbon black.

In yet another embodiment, the cathode may be an air cathode, thereby forming an aluminum-air battery.

In one non-limiting example, the cathode is prepared from Co(AlCl₄)₂ mixed with powdered graphite to make it conducting (and a binder to hold the material together). In this example, the net reaction during charging will be oxidation of Co(II) to Co(III). During this process, the AlCl₄⁻ anion will be incorporated in the cathode for charge balance. The structure of Co(II) complexed by AlCl₄⁻ anions in an ionic liquid has been shown to be discrete ions with the composition [Co(AlCl₄)₃]⁻ in which the tetrachloroaluminate ions are bidentate and the Co(II) center is octahedrahedrally coordinated. The structure of Co(AlCl₄)₂ in the solid state has four tetrachloroaluminate centers bound to each Co(II), two with bidentate coordination and two that are monodentate but bridging. Co(III) will always be octahedrally coordinated. Thus, oxidation of Co(II) to Co(III) is not expected to cause a large change in the coordination environment of the Co center.

In other non-limiting examples, Ti(II) and Mn(II) complexes may also be considered as a transition element for the cathode material.

In another embodiment, the cathode material is λ-MnO₂. In one example, during the cycle, Al dissolves in the electrolyte from the anode and AlCl₄⁻ anions are formed, consuming the Cl⁻ anions generated when Al(III) cations are incorporated in the cathode. During discharge, manganese in oxidation state IV will be reduced to a lower oxidation state at the cathode and the Al(III) ions enter the solid to compensate for the charge. In certain embodiments, the cathode material can be prepared in a “reduced” or uncharged state by reacting MnO₂ with triethylaluminum in a similar manner that butyllithium is used to incorporate Li in cathodes for Li-ion batteries. The cathode may then be “charged” by oxidation of the Mn oxide resulting in expulsion of Al(III) ions, which are subsequently complexed by chloride ions and then plated at the anode.

Spinel-type MnO₂ may be made by treating LiMn₂O₄ with aqueous acid. This λ-MnO₂ has the same structural framework of spinet, but with most of the lithium removed from the tetrahedral sites of the spinel lattice. The mechanism for the conversion of LiMn₂O₄ to λ-MnO₂ involves a disproportionation of the Mn³⁺ ions into Mn⁴⁺ (remains in the solid) and Mn²⁺ (leaches out into the aqueous solution). It is possible to insert Al³⁺ into spinel λ-Mn₂O₄ to form spinel AlMn₂O₄. In one embodiment, the following discharge reactions can occur in an aluminum battery (the reverse reactions will occur during charge), as shown in equations (4), (5), and (6):

Electrolyte: AlCl₃+[EMI]⁺Cl⁻ [symbol] [EMI]⁺AlCl₄⁻ (4)

Anode: Al+7[AlCl₄]⁻ [symbol] 4[Al₂Cl₇]⁻+3e⁻ (5)

Cathode: λ-Mn₂O₄+4[Al₂Cl₇]⁻+3e⁻ [symbol] AlMn₂O₄+7[AlCl₄]⁻ (6)

Net reaction: λ-Mn₂O₄+Al→AlMn₂O₄ (7)

where:

λ-Mn₂O₄≡(□)ₜₑₜ[Mn₂]_{oct}O₄;

AlMn₂O₄≡(Al)ₜₑₜ[Mn₂]_{oct}O₄; and

wherein the subscripts “tet” and “oct” refer, respectively, to 8a tetrahedral and 16d octahedral sites in the spinel lattice.

The edge-shared Mn₂O₄ spinel framework into/from which Al³⁺ ions could be reversibly inserted/extracted is stable. The 3-dimensional diffusion of Al³⁺ ions from one 8a tetrahedral site to another 8a tetrahedral site via the neighboring empty 16c octahedral site can support fast aluminum-ion diffusion through the lattice. Additionally, the edge-shared Mn₂O₄ framework with direct Mn-Mn interaction can provide good electronic conduction. The fast aluminum-ion diffusion together with the good electronic conduction can support high rate capability. The electrochemical cell can be represented as:

λ-Mn₂O₄|AlCl₃+[EMI]⁺Cl⁻|Al Theoretical voltage: 2.65 V

The theoretical capacities for the aluminum battery including a λ-Mn₂O₄ cathode are calculated and shown in Table 1 below. From these theoretical calculations, the aluminum battery has a distinct edge in capacity and energy density over the state-of-the-art Li-ion batteries.

TABLE 1
Calculated Theoretical Capacity for Aluminum Battery

| | | Cell Energy | |
|---|---|---|---|
| | Cell Capacity | Density | Cell |
| System | (mAh/g) | (Wh/kg) | Voltage (V) |
| Li-ion battery; | 140 | 404 | 4 |
| C₆—LiCoO₂ | | | |
| Al battery; | 400 | 1,060 | 2.65 |
| Al-λ-Mn₂O₄ | | | |
| Al battery; | 329 | 872 | 2.65 |
| C₆-λ-Mn₂O₄ | | | |
| Al-ion battery; | 274 | 315 | 1.15 |
| TiO₂-λ-Mn₂O₄ | | | |

In certain embodiments, methods of making an aluminum battery comprise providing an anode comprising aluminum metal. In certain embodiments, the methods further comprise providing a cathode comprising a material capable of intercalating aluminum ions during a discharge cycle and deintercalating the aluminum ions during a charge cycle. In certain embodiments, the methods further comprise providing an electrolyte capable of supporting reversible deposition and stripping of aluminum at the anode, and reversible intercalation and deintercalation of aluminum at the cathode. In some embodiments, the electrolyte comprises an ionic liquid. In other embodiments, the electrolyte comprises an organic solving having a high dielectric constant.

In some embodiments, batteries for grid storage applications may be formed. In other embodiments, batteries for vehicle applications may be formed. In yet other embodiments, batteries for portable electronic devices may be formed.

In another example, a coin cell battery may be formed. In such an example, a cathode slurry for the battery may be made by homogenizing the active components of the cathode with the carbon material (such as carbon black, for example) and the binder (such as PVdF binder in N-methylpyrrolidinole, for example). In certain embodiments, the cathode slurry is dried at an elevated temperature (>100° C.) and then pressed under a load (e.g., 1 ton load) for a certain length of time before cutting into a disk (e.g., 1.3 cm diameter disk). In some embodimens, the cathode disks are further dried at an elevated temperature (>100° C.) under a vacuum before assembling into the coin cell battery. In certain embodiments, the coin cell battery is assembled with an aluminum anode, MnO₂ cathode, and an acidic electrolyte mixture of 2:1 AlCl₃:EMIC as the electrolyte with either Celgard or carbon fiber filter paper as the separator. In certain embodiments, the cells may be cycled under different current densities on Arbin instruments.

While the invention as described may have modifications and alternative forms, various embodiments thereof have been described in detail. It should be understood, however, that the description herein of these various embodiments is not intended to limit the invention, but on the contrary, the intention is to cover all modifications, equivalents, and alternatives falling within the spirit and scope of the invention as defined by the claims. Further, while the invention will also be described with reference to the following non-limiting examples, it will be understood, of course, that the invention is not limited thereto since modifications may be made by those skilled in the art, particularly in light of the foregoing teachings.

### EXAMPLES

### Example 1

In this example, the salt of EMIC was synthesized and purified, and three electrolyte mixture AlCl₃ and EMIC were made. The ratios of AlCl₃:EMIC were approximately 1:1.5 (basic), 1:1 (neutral), and 2:1 (acidic). All three electrolytes were tested for their electrochemical potential using a platinum and aluminum coin cell disks for the cathode and anode, with the electrolyte coupled with aluminum wire. The results are shown in FIGS. 2A and 2B.

It was observed that the neutral ionic liquid electrolyte (1:1 AlCl₃:EMIC) had the widest electrochemical potential window (FIG. 2A). However, the aluminum reaction only proceeded in the acidic electrolyte (2:1 AlCl₃:EMIC). In the acidic electrolyte, the current efficiency of the aluminum reaction (C_{dissolution}/C_{deposition}) was observed to be close to 100% (FIG. 2B).

### Example 2

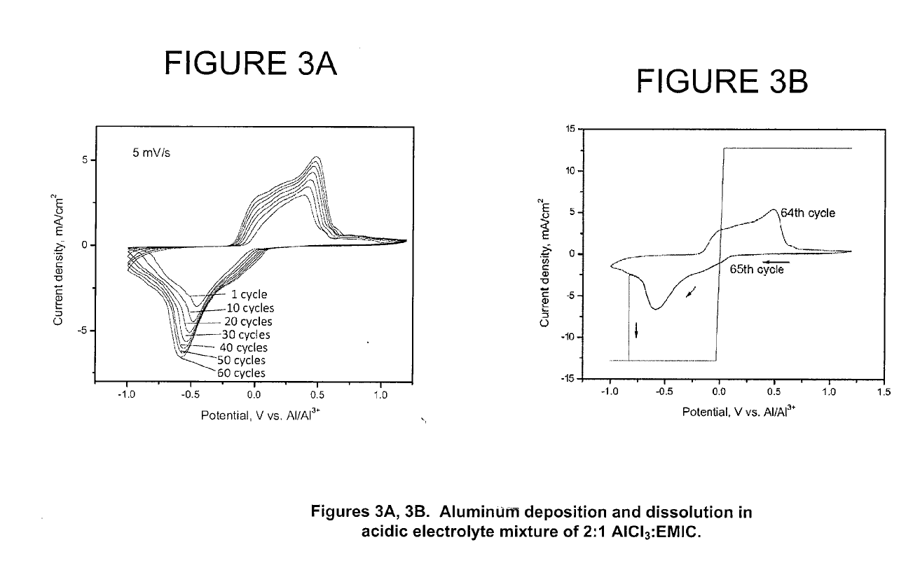

Aluminum deposition and dissolution were studied using similar test parameters as Example 1 for an acidic electrolyte mixture of 2:1 AlCl₃:EMIC. Sixty-five charge/discharge cycles were carried out at 5 mV/s. The results are shown in FIGS. 3A and 3B.

It was observed that the acidic electrolyte mixture was capable of intercalating aluminum ions during the discharge cycles and deintercalating the aluminum ions during the charge cycles before perceived failure in the 65th cycle.

### Example 3

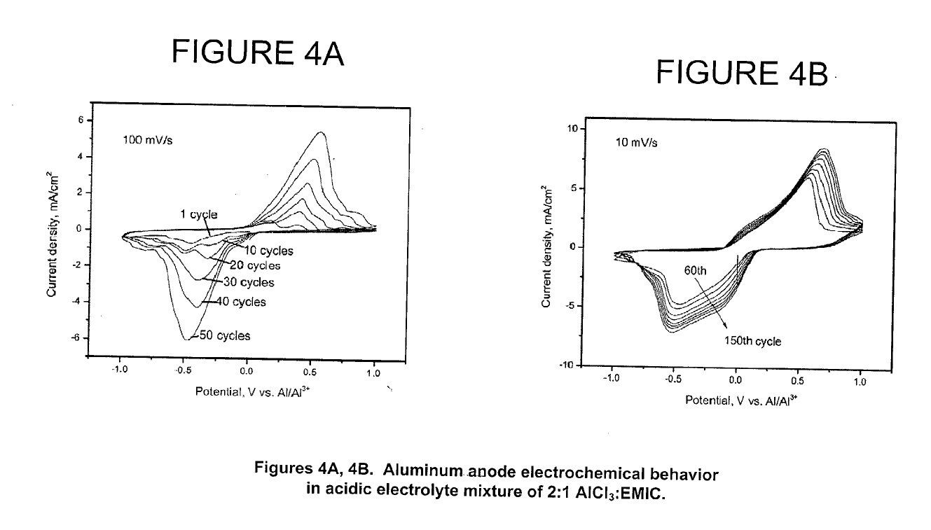

Aluminum anode electrochemical behavior was studied using similar test parameters as Example 1 for an acidic electrolyte mixture of 2:1 AlCl₃:EMIC. Tests were carried out at 100 mV/s for 50 cycles and 10 mV/s for 150 cycles. The results are shown in FIGS. 4A and 4B.

It was observed that the aluminum anode showed good cyclability and high current density in the acidic electrolyte mixture for 150 cycles.

### Example 4

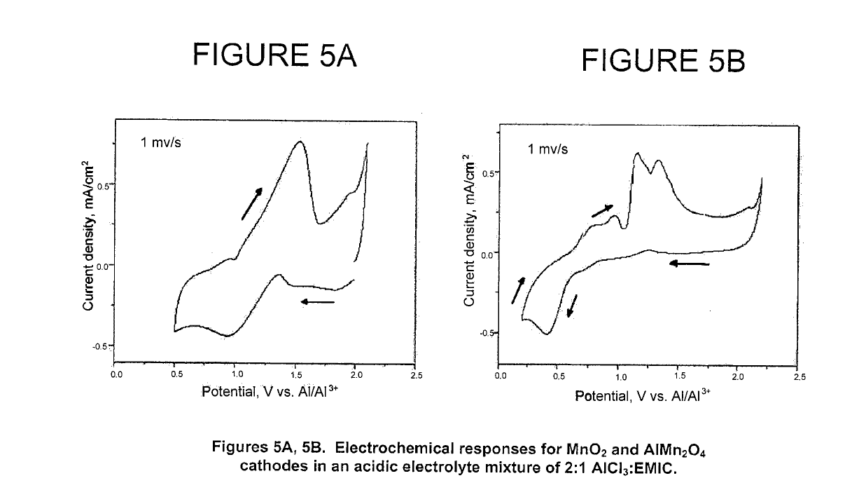

MnO₂ and AlMn₂O₄ cathode materials were studied for their electrochemical response using similar test parameters as Example 1 for an acidic electrolyte mixture of 2:1 AlCl₃:EMIC. Tests were carried out at 1 mV/s. The results are shown in FIGS. 5A and 5B.

It was observed that both MnO₂ and AlMn₂O₄showed redox activity in the acidic electrolyte mixture.

### Example 5

In this example, a coin cell battery was prepared. The cathode slurry was prepared with 80wt% of active materials (MnO₂ or AlMn₂O₄), 10 wt % carbon black and 10 wt % PVdF binder in N-Methylpyrrolidinole. The slurry was homogenized for about 5 min before casting on stainless steel foil with a doctor blade. After drying at approximately 120° C., the electrode was pressed under 1 ton load for about 1 min before cutting into discs with diameter of approximately 1.3 cm. The electrode discs were further dried at approximately 120° C. under vacuum for 24 hrs before assembling coin cells. The coin cells were assembled inside a well controlled Argon filled glove box with both moisture and oxygen levels below 1 ppm. The coin cells were assembled with aluminum as the anode, MnO₂ as the cathode, and an acidic electrolyte mixture of 2:1 AlCl₃:EMIC as the electrolyte with either Celgard or carbon fiber filter paper as the separator. The cells were cycled under different current densities on Arbin instruments.

What is claimed is:

1. A battery comprising:
an anode comprising aluminum metal;
a cathode comprising a material capable of intercalating aluminum ions during a discharge cycle and deintercalating the aluminum ions during a charge cycle; and
an electrolyte capable of supporting reversible deposition and stripping of aluminum at the anode, and reversible intercalation and deintercalation of aluminum at the cathode.

2. The battery of claim 1, wherein the battery is a primary battery.

3. The battery of claim 2, wherein the cathode material is selected from the group consisting of Ti(AlCl₄)₂, MnCl(AlCl₄), Co(AlCl₄)₂.

4. The battery of claim 1, wherein the battery is a secondary battery.

5. The battery of claim 4, wherein the secondary battery maintains a discharge capacity of at least 50% of an initial discharge capacity after 50 discharge cycles.

6. The battery of claim 1, wherein the cathode material is selected from the group consisting of Mn₂O₄, Ti(AlCl₄)₂, MnCl(AlCl₄), Co(AlCl₄)₂, and V₂O₅.

7. The battery of claim 1, wherein the cathoide material comprises spinel-Mn₂O₄.

8. The battery of claim 1, wherein the cathode material comprises V₂O₅.

9. The battery of claim 1, wherein the electrolyte comprises an ionic liquid.

10. The battery of claim 9, wherein the ionic liquid is an aluminate selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, and mixtures thereof.

11. The battery of claim 10, wherein the electrolyte further comprises aluminum chloride, and the ratio of aluminum chloride to the aluminate is greater than 1:1.

12. The battery of claim 11, wherein the electrolyte further comprises an alkali metal halide additive.

13. The battery of claim 12, wherein the alkali metal halide additive is selected from the group consisting of: NaCl, KCl, NH₄Cl, and mixtures thereof.

14. The battery of claim 9, wherein the electrolyte comprises ethylmethylimidazolium tetrachloroaluminate and aluminum chloride.

15. The battery of claim 14, wherein the molar ratio of aluminum chloride to ethylmethylimidazolium tetrachloroaluminate is greater than 1:1.

16. The battery of claim 15, wherein the electrolyte further comprises an alkali metal halide additive.

17. The battery of claim 16, wherein the alkali metal halide additive is selected from the group consisting of: NaCl, KCl, NH₄Cl, and mixtures thereof.

18. The battery of claim 9, wherein the ionic liquid is a neutral ionic liquid comprising:
a cation having one of the following structures: 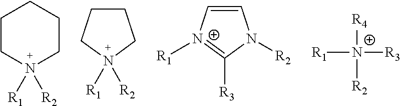
wherein R₁, R₂, R₃, and R₄ each independently comprise a non-ionizable substitutent; and
a anion having one of the following structures: CF₃SO₃⁻, B(CO₂)₄, N(SO₂CF₂CF₃)₂, N(SO₂CF₃)₂⁻, N(SO₂F)₂⁻, PF₆⁻, BF₄⁻, and BF₄₋ₓ(CₙF₂ₙ₊₁)ₓ⁻, wherein x=1, 2, or 3, and n=1, 2, 3, 4, 5, 6, 7, 8, 9, or 10.

19. The battery of claim 1, wherein the electrolyte comprises an organic solving having a high dielectric constant.

20. The battery of claim 19, wherein the organic solvent is selected from the group consisting of propylene carbonate, ethylmethylsulfone, ethylmethoxyethylsulfone, and methoxyethylmethylsulfone.

21. The battery of claim 20, wherein the cathode material is selected from the group consisting of spinel-Mn₂O₄, Ti(AlCl₄)₂, MnCl(AlCl₄), Co(AlCl₄)₂, and V₂O₅.

22. The battery of claim 1, wherein the battery is used in a grid storage application, vehicle battery application, portable electronic device application, or standard cell size battery application.

23. A battery comprising:
an aluminum metal anode;
a λ-MnO₂ cathode capable of intercalating aluminum ions during a discharge cycle and deintercalating the aluminum ions during a charge cycle; and
an ionic liquid electrolyte comprising aluminum chloride and ethylmethylimidazolium tetrachloroaluminate, having a molar ratio of aluminum chloride to ethylmethylimidazolium tetrachloroaluminate greater than 1:1;
wherein the electrolyte is capable of supporting reversible deposition and stripping of aluminum at the anode, and reversible intercalation and deintercalation of aluminum at the cathode.

24. The battery of claim 23, wherein the battery maintains a discharge capacity of at least 50% of an initial discharge capacity after 50 discharge cycles.

25. A method of making a battery comprising:
providing an anode comprising aluminum metal;
providing a cathode comprising a material capable of intercalating aluminum ions during a discharge cycle and deintercalating the aluminum ions during a charge cycle; and
providing an electrolyte capable of supporting reversible deposition and stripping of aluminum at the anode, and reversible intercalation and deintercalation of aluminum at the cathode.

26. The method of claim 25, wherein the cathode material is selected from the group consisting of Mn₂O₄, Ti(AlCl₄)₂, MnCl(AlCl₄), Co(AlCl₄)₂, and V₂O₅.

27. The method of claim 25, wherein the electrolyte comprises aluminum chloride and an ionic liquid aluminate selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, and mixtures thereof; wherein the ratio of aluminum chloride to the aluminate is greater than 1:1.

28. The method of claim 27, wherein the electrolyte further comprises an alkali metal halide additive.

29. The method of claim 25, wherein the electrolyte comprises ethylmethylimidazolium tetrachloroaluminate and aluminum chloride; wherein the molar ratio of aluminum chloride to ethylmethylimidazolium tetrachloroaluminate is greater than 1:1.

30. The method of claim 29, wherein the electrolyte further comprises an alkali metal halide additive.

31. The method of claim 25, wherein the electrolyte is a neutral ionic liquid electrolyte comprising:
a cation having one of the following structures: 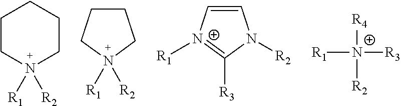
wherein R₁, R₂, R₃, and R₄ each independently comprise a non-ionizable substitutent; and
a anion having one of the following structures: CF₃SO₃⁻, B(CO₂)₄⁻, N(SO₂CF₂CF₃)₂, N(SO₂CF₃)₂, N(SO₂F)₂, PF₆⁻, BF₄⁻, and BF₄⁻, and BF₃₋ₓ(CₙF₂ₙ₊₁)ₓ⁻; wherein x=1, 2, or 3, and n=1, 2, 3, 4, 5, 6, 7, 8, 9, or 10.

32. The method of claim 25, wherein the electrolyte comprises an organic solvent selected from the group consisting of propylene carbonate, ethylmethylsulfone, ethylmethoxyethylsulfone, and methoxyethylmethylsulfone.
